(19) United States
(12) Patent Application Publication
(10) Pub. No.: US 2024/0320551 A1
(43) Pub. Date: Sep. 26, 2024

(54) AUTONOMOUS VIRTUAL ENTITIES CONTINUOUSLY LEARNING FROM EXPERIENCE

(71) Applicant: HAVELSAN HAVA ELEKTRONIK SANAYI VE TICARET ANONIM SIRKETI, Ankara (TR)

(72) Inventors: Arif Furkan MENDI, Ankara (TR); Tolga EROL, Ankara (TR); Mehmet KOZAN, Ankara (TR); Turan TOPALOGLU, Ankara (TR); Senol Lokman ALDANMAZ, Ankara (TR); Duygu CENET, Ankara (TR); Serdar YILGIN, Ankara (TR); Mehmet Onur OZCELIK, Ankara (TR); Muhittin SOLMAZ, Ankara (TR); Huseyin Oktay ALTUN, Konya (TR); Muhammet Esat KALFAOGLU, Konya (TR); Cihan CALISIR, Konya (TR); Huseyin Furkan CERAN, Konya (TR); Emre FISNE, Konya (TR); Ahmet MUTLU, Konya (TR); Fatiha Nur BUYUKOFLAZ, Ankara (TR)

(73) Assignee: HAVELSAN HAVA ELEKTRONIK SANAYI VE TICARET ANONIM SIRKETI, Ankara (TR)

(21) Appl. No.: 18/575,422

(22) PCT Filed: Sep. 8, 2022
(86) PCT No.: PCT/TR2022/050960

§ 371 Date: Dec. 29, 2023

(30) Foreign Application Priority Data
Sep. 8, 2021 (TR) 2021/014085

(51) Int. Cl. G06N 20/00

(52) U.S. Cl. CPC G06N 20/00

(57) ABSTRACT

An artificial intelligence model is provided, where virtual entities used in educational training simulations are transitioned from a rule-based behavior function to an artificial intelligence-based learning behavior function and thereby the virtual entities improve themselves, and a method in which the virtual entities improve themselves. The autonomous virtual entities that are trained with supervised learning and reinforcement learning algorithms as the training algorithm by being interacted with the simulation are designed.

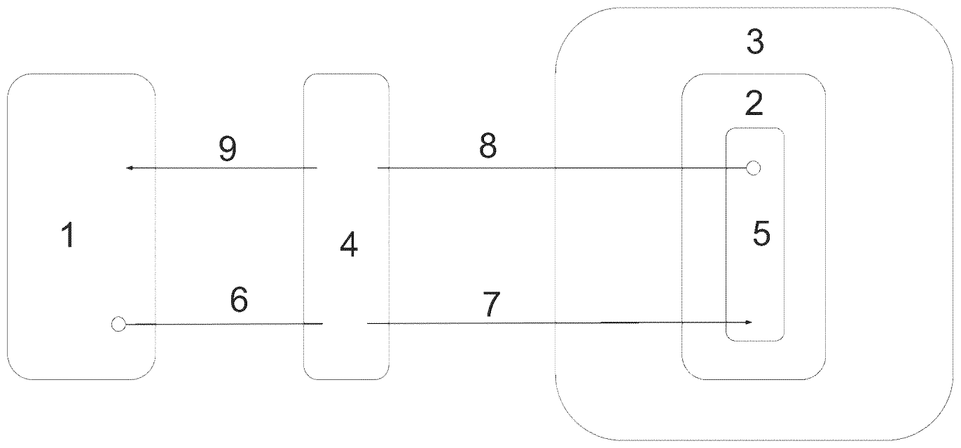

### CROSS REFERENCE TO THE RELATED APPLICATIONS

This application is the national phase entry of International Application No. PCT/TR2022/050960, filed on Sep. 8, 2022, which is based upon and claims priority to Turkish Patent Application No. 2021/014085, filed on Sep. 8, 2021, the entire contents of which are incorporated herein by reference.

### TECHNICAL FIELD

The invention relates to designing an artificial intelligence model wherein virtual entities used in educational training simulations are transitioned from a rule-based behavior function to an artificial intelligence-based learning behavior function and thereby the virtual entities improve themselves, and a method in which the virtual entities improve themselves.

### BACKGROUND

Rule-based approaches for behavioral control of an entity in the simulations are insufficient in order to model a real-world environment, and the designing of rules takes a significant amount of time, especially in a scenario with many entities.

Since the level of self-improvement of the trainees trained in the educational simulations using rule-based approach directly depends on the knowledge of the experts who prepare the scenarios and the rules themselves, they fall far behind the live training in the real-world.

These rule-based approaches do not satisfy the trainees and they do not promise in high-risk scenarios as well. The fact that there are many variations of situations, the uncertainty and the need to find solutions to the unexpected cases occurring during the live training are the factors that increase the quality of the training.

Since there is no system that updates the rule-based behavior function with respect to the current experience level of the trainees, these virtual environments that progress with stationary behavior functions are far from the ideal of gaining experience by developing new strategies, therefore the simulations cannot come to close to the real-world operational environment level with the traditional approaches.

In training simulation softwares, virtual entities in the environment are controlled by humans manually or traditional methods based on pre-programmed rules. Trainees are expected to observe as many various situations as possible in the scenario and thus gain experience. One of the main disadvantages of rule-based behaviors is that they are pre-programmed for these specific and pre-defined scenario conditions. Rule-based virtual entities are insufficient to handle the situations that occur unexpectedly during training. Virtual entities using AI-based behavior models can overcome this problem as they use a policy that can generalize different variations thanks to their training. These entities, which are not modeled for specific situations and can produce solutions to unexpected situations, always have the feature of being open to development and adapting to the environment.

In complex simulation environments, there may be the interaction of many virtual entities. As the complexity in the scenario increases due to the number of entities, programming the behavior model of these entities is not possible with conventional rule-based approaches. Since the interactions between each entity in the scenario can be learned with artificial intelligence approaches, system scalability in terms of entity amount can be provided and behavior model can be approximated regardless of the number of entities in the scenario. This saves both the rule programmer (field expert and software developer) and the user from an important problem.

One of the most important features demanded from a training simulator is its realism. Since pre-defined and stationary rule-based control mechanisms give robotic behaviors to virtual entities, the realism of the simulation environment is damaged. Similar to humans, intelligent virtual entities, who learn from their experiences over time, can improve themselves and find new strategies according to the situation they are in, are making a positive contribution in order to provide more realistic simulation environments.

In order to get maximum efficiency from training simulators during training, it is a widely used method to determine the behavior models of the entities that are being opposed by the trainees during the training according to the experience level of the trainees. However, this means that there is a need to adapt to a wide variety of experience levels when preparing rule-based behavior models since each trainee has individual experience level. Therefore, rule-based behavior models compatible with different levels of experience must be designed.

Intelligent virtual entities can be trained at the level of trainees who will compete with them, and the desired match can be achieved. Obviously, realistic modeling of the behavior of virtual entities is important for trainees to improve in the right direction. Trainees educated with the existing traditional approaches can improve themselves to the extent of the experience level of experts and software developers who design rule-based behavior mechanisms in the related field. When viewed from this aspect, artificial intelligence algorithms can gain the basic domain knowledge from the rule-based behavior models designed by the human experts in the early training. Moreover, they can generate new solutions for people as they keep learning.

The United States Patent document numbered US2020293862A1 in the state of the art describes a reinforcement learning system implemented as computer programs on one or more computers at one or more locations that select actions to be performed by an agent interacting with an environment. Generally, the system uses an action selection policy neural network when choosing actions to take in response to observations that characterize environmental situations.

In the Chinese patent document numbered CN106952014A in the state of the art, the battle plan optimization method that is based on a military simulator is mentioned. Through the method, a battle plan can be created and optimized automatically. Therefore, a better military operational plan decision-making recommendation is provided for the personnel that makes military decisions.

The Chinese patent document numbered CN106682351 in the state of the art relates to the technical field of battlefield simulation training, especially a battle simulation system and a simulation method that is based on computer-generated forces. The invention provides a combat simulation system that generates military forces generated by the computer and a simulation method and relates to the technical field of simulative training on battlefields. A method that can automatically respond to events and situations without human interaction in a simulated battlefield environment by modeling human behavior sufficiently, and can simulate possible outcomes in real combat situations is mentioned.

Intelligent virtual entities that learn as they operate provide a more realistic virtual environment by generating new strategies that have not yet been discovered by the human experts in the related field or the literature, and create a potential for the trainees to be trained towards the right direction. In Tactical Environment Simulators, there is a need to simulate tactical entities that should behave in accordance with a determined scenario. It is important that these tactical entities obtain intelligent and adaptable behavior policy by learning from experience. In this way, it will be able to perform the roles assigned to it in a way that is similar to the real world situation and enable tactical environment simulation to serve its purposes better.

Therefore, there is a need for developing an artificial intelligence model in which virtual entities improve themselves in training simulations.

### SUMMARY

The object of the present invention is to provide a simulation which comprises tactical entities that should behave in accordance with a determined scenario.

Another object of the invention is to provide a simulation which has the intelligence and adaptability to learn from the experience of tactical entities.

Another object of the invention is to provide a training simulation which has virtual entities that will be able to perform the roles assigned to them in a way that is similar to the real world scenarios and enable tactical environment simulation to serve its purposes better.

### BRIEF DESCRIPTION OF THE DRAWINGS

An artificial intelligence model and the method with which the virtual entities improve themselves in the training simulators realized to achieve the objectives of the present invention are shown in the attached FIGURE.

In this FIGURE,

FIGURE is a schematic view of the basic elements of an artificial intelligence model in which the virtual entities improve themselves.

The systems in the FIGURE have been numbered individually, and the corresponding descriptions are given below:
10. Training algorithms
11. Virtual entities
12. Simulation
13. Training interface
14. Behavior model
15. Raw action generated by the artificial intelligence model
16. Processed action which is interpretable by the simulation
17. Raw state generated by the simulation
18. Processed state, reward which is interpretable by the artificial intelligence model

### DETAILED DESCRIPTION OF THE EMBODIMENTS

The invention is a self-improvement method of virtual entities with an artificial intelligence model in training simulators, comprising the steps of;
Developing an optimal behavior model (5) with a deep learning approaches for managed intelligent virtual entities (2) controlled with supervised learning training algorithms (1),
Connecting training algorithms (1) and simulations (3) with the intelligent virtual entities (2),
Learning the appropriate behavior model (5) by trial and error according to punishment-reward or the objective function with reinforcement learning after the supervised learning training.

The method of the invention has 3 basic components. This structure has been shown in FIGURE. The first component is the training algorithms (1) which form the basis of the system. Here, an optimum behavior model (5) is attempted to be learned for controlled intelligent virtual entities (2). The developed training algorithms (1) are deep learning algorithms. Educational methods can be divided into supervised learning and reinforcement learning. From this aspect, supervised learning can be considered as learning the behavior designed by a human expert. If there is expert data which is recorded in the form of annotated states with the corresponding action pairs at each step, the system is trained with this data and it gains an initial impression about the scenario. Then, the training is continued with reinforcement learning. Reinforcement learning basically can be defined as learning by trial and error. The system attempts to learn the appropriate behavior model (5) by trial and error according to the designed reward function. At this point, the system can be started from scratch directly with reinforcement learning, but in this case, the training period will take much longer.

As the second component, there are intelligent virtual entities (2). In fact, these are entities that operate in the simulation (3) with respect to a behavior function. Therefore, in the developed simulation (3), it is assumed that a behavior function (5) can be assigned to the entities. The improvement made here is the technique of using the entity as an interface by connecting it to the training algorithm (1). Thanks to this technique, the virtual entity (2) is able to implement the behavior model (5) developed with artificial intelligence. This structure is connected to the training interface (4), which is expressed as “gym” in the training algorithms (1). This training interface (4) transmits the actions of the entity, the raw action (6), with a function, and receives the new state obtained as a result of this action.

Simulation (3), on the other hand, is a high-fidelity structure that models the real world on which the developments are made. No development is made here, processed actions (7) which are interpretable by the simulation (3) are transmitted into the simulation (3), and decisions are made with the state space coming from the simulation (3).

Although the invention is prioritized in the simulation (3) environment, it can also be used as a decision support system where it is compatible with the domain in which the simulation (3) environment is located, proportional to how well the simulation (3) models the real world. That is because the virtual entity (2) learns the most appropriate behavior according to the objective function designed for the situations the virtual entity is facing. Therefore, it can advise as a decision support system for real platforms and operational environments in similar conditions. Besides, since the invention uses high computational capabilities with artificial intelligence systems, it can make decisions much faster than a human operator. Therefore, it can become a very useful system in situations where quick decisions are required.

In addition, the usage of the system can evolve into a situation in which user-level-based training is possible. Considering that these virtual entities (2) are continuously learning, it is thought that they can evolve into a structure that will allow the user to choose a level in a session. For example, a less trained entity can be presented to the trainees as an easy level, while a more trained entity can be presented to a more professional trainee.

The scope and realism of the scenarios prepared for the tactical environment simulations (3) using rule-based behavior functions are limited by the ability of the rule-based behavior designers who prepared the scenario. To remove this limitation, virtual entities (2) which learn by trial and error and which can make more accurate decisions when encountered with unfamiliar situations were considered to be added to the simulation (3) environment.

Basically, if the procedure steps for solving the problem are listed, 8 steps can be specified. These can be listed as state-space analysis, action space analysis, simulation (SDK) analysis, preparation of the gym (training interface) interface (4), examination of rule-based behavior models or expert data if any, application of supervised learning algorithms, application of reinforcement learning algorithms and single agent or multi-agent trainings.

### State Space Analysis

The data in Table-1 taken from the simulation are used in the state space:

TABLE 1
State Space Data
State Space Data

| | |
|---|---|
| 1 | Position, altitude, speed, heading, and orientation attributes of the controlled virtual entity and its potential |
| | hostiles |
| 2 | Type attributes of the controlled virtual entity and its potential hostiles |
| 3 | Situational awareness of the controlled virtual entity which is obtained with its sensor capabilities |
| 4 | Type and amount of remaining ammunition of the controlled virtual entity |
| 5 | Situational awareness of the controlled virtual entity which is obtained as a result of IFF usage |
| 6 | Tactical awareness and tactical mission assignments of the controlled virtual entity by communicating with at |
| | most one friendly unit |
| 7 | Estimates of the countermeasure maneuver capabilities of the potential hostiles of the controlled virtual entity |
| 8 | Route properties of the controlled virtual entity |
| 9 | Weather, time of day and terrain conditions |
| 10 | Situational awareness and tactical mission assignments obtained by the controlled virtual entity by using a |
| | radio message |
| 11 | Damage status of the controlled virtual entity |
| 12 | Remaining fuel status of the controlled virtual entity |
| 13 | Formation properties which the controlled virtual entity obeys |

### Action Space Analysis

The basic actions and parameters of the algorithm to be used in the action analysis in the targeted invention are given in Table-2 and Table-3.

TABLE 2
Basic action categories
Basic Action Categories

| | |
|---|---|
| 1 | Maneuver Actions (Parameter details are given in Table 2). |
| 2 | Weapon Actions (Munition Type, Firing Mode) |
| 3 | IR Flare Actions (Release Flares) |
| 4 | Chaff Actions (Release Chaff) |
| 5 | IR Jamming Actions (On, Off, Auto) |
| 6 | Radar Jamming Actions (On, Off, Auto) |
| 7 | Laser Jamming Actions (On, Off, Auto) |
| 8 | IFF Actions (Mode, Code) |
| 9 | Smoke Actions (On, Off, Auto) |
| 10 | Sensor Actions (Mode, On, Off) |
| 11 | Communication Actions (Send Message, Receive Message) |

TABLE 3
Basic actions and parameters

| Basic actions | Parameters |
|---|---|
| Track | Identity information of the platform to be |
| | tracked |
| | Minimum/maximum tracking distance (meters) |
| | Tracking angle (degrees) |
| | Tracking altitude (meters) |
| Go to the Location | Coordinate information |
| | Expected time of arrival or Advancing Rate |
| | (knots) |
| | Rotation Speed (Optional) (degrees/sec) |
| | Climb/Dive Speed (Optional) |
| | Acceleration/Deceleration (Optional) ( ) |
| | Altitude (Optional) (meters) |
| Go to the Player | Player identity information |
| | Approach distance (meters) |
| | Approach angle (degrees) |
| | Approach altitude (meters) |
| | Rotation Speed (Optional) |
| | Climb/Dive Speed (Optional) |
| | Acceleration/Deceleration (Optional) ( ) |
| Move with the Given | Direction (degrees) |
| Values Directional | Speed (knots) |
| Knowledge (Degrees) | Rotation Speed (Optional) |
| | Climb/Dive Speed (Optional) |
| | Acceleration/Deceleration (Optional) ( ) |
| | Altitude (meters) |
| Enter the Mission Route | Route identity information |
| | Route deviation distance (Optional) (meters) |
| | Route deviation angle (Optional) (meters) |
| | Route Track Type (Optional) |

### Simulation (SDK) Analysis

Tactical Environment Simulation Software, used for tactical training in simulators of combatant platforms, is a simulation software that provides tactical scenario planning, running the planned scenario, post-training evaluation and debriefing.

In the current situation; a virtual tactical operation environment as realistic as possible is needed for the training of weapons, sensors, counter measures, jamming and communication systems, especially in mission simulators of combat platforms, to provide comprehensive tactical training. Entities that can perform the roles of the possible friendly, enemy and neutral forces in this virtual operational environment, and that can perform offensive and/or defensive missions realistically are needed.

These entities should be able to represent the real world physically (aerodynamics, range, detection, optics, etc.) and perform the behavior of the real-life operators (doctrines, tactics, experience, etc.) realistically in this virtual world.

### Preparation of “Gym” (Training Interface) Interface (4)

Gym is an application programming interface developed to improve and compare reinforcement learning algorithms. Virtual entities trained in the environment can perform the actions sequentially and the reward (9) they will receive according to the action taken and the state changes in the environment caused by this action are the basic features that must be met for a standard reinforcement learning training. In order to train a virtual entity, the entity has to run the same scenario repeatedly and reach its goal with sequential actions in the same environment and get the maximum reward (9).

In the present invention, the gym training interface (4) has been prepared so that the virtual entities in the related simulation can send the action and receive the state which is fed to the memory of the virtual entity from the simulation at every step. The basic functions of the gym training interface (4) are as mentioned below. Other functions are used to transfer data in the thread structure of the virtual entity with the simulation.
step: the function that takes the actions chosen by the virtual entity at every step as an input argument, sends them to the simulation with the thread structure, returns the new state values, the status of the termination, and the reward (9) value returned from the reward function according to the action chosen
reset: the function that enables the simulation to be returned to its initial state in cases where the trained virtual entity reaches the defined objective or the entity is demolished
get_reward: the function that calculates the reward (9) according to the action chosen by the virtual entity and passes this value to the step function

Reinforcement learning algorithms widely used today are designed by developers to be compatible with “gym” environments. Therefore, a conventional standard main structure used in reinforcement learning algorithms has been formed. The use of the “gym” training interface (4) within the invention has enabled the algorithmic structure of the invention to be adapted to any up-to-date reinforcement learning algorithm. In other words, while any reinforcement learning algorithm in the literature can be used with the invention, the training algorithm currently used in the invention can be used in the standard open source “gym” environments.

Gym training interface (4) has specific sub-methods of its own as well. The first of these is the reward function. The state and action space are prepared and manipulated within the gym as well.

### Review of Rule-Based Behavior Models or Expert Data, if any

The main purpose of studying rule-based behavior functions is to understand the implementation procedures of decision-making mechanisms in order to observe state information and apply selected action in the simulator environment. If the inner rule-based behavior mechanism embedded in the virtual entity in the simulator environment is removed and taken to the outside of the simulator environment, the accuracy of the communication traffic which consists of sending state to the outer decision-making mechanism and executing action received from the outer decision-making mechanism within the invention becomes observable. If the virtual entity does not perform the expected rule-based behaviors, this will guide the developer by pointing to a possible problem in the “gym” training interface (4) as one of the communication providing components of the invention. Therefore, the rule-based behavior model (5) has a reference role for the system-wise accuracy of the invention. In addition, it helps the determination of state information that may be reasonable in terms of decision-making for the state space that the invention will use in the training algorithm. On the other hand, rule-based behavior models often contain useful ideas for the rewarding which is one of the cornerstones of reinforcement learning. Rule-based defense and offense strategies are analyzed and the reward function is shaped accordingly. In addition, the state observed by the rule-based behavior model (5) at each step and the corresponding action selected is recorded as state action pairs, and an expert dataset is obtained. This dataset is used in supervised learning algorithms. This analysis is also used in the evaluation of the training algorithm. By taking the average score that the reward function evaluates for the rule-based behavior model (5) as the reference criterion, an impression about the performance can be obtained by making use of the distance of the average score captured by the learning algorithm from the reference score.

### Application of Supervised Learning Algorithms

In supervised learning, each data sample is annotated by a label which indicates what the exact right prediction is supposed to be. By this means, the model can establish a correlation between input and output. Following the training, by providing both the training data and test data of the same dataset; it is expected that the model will predict the output of these data as much as the number of samples given. In this case, the models that are found to be successful according to the accuracy or loss value can be considered as learned models.

Supervised learning is used in additional tasks such as route estimation, in addition to training virtual entities with reinforcement learning mentioned in the present invention. Here, the dataset required for training is collected over the virtual entity with rule-based behavior function run in a determined scenario. The collected data is divided into input and output. Input data includes values such as raw data (8), fuel status of the virtual entity, and location information. Output data, the processed data (9), can be manipulated according to the purpose expected from the model. For example, if it is desired to predict where the virtual entity will be positioned every time it takes an action before it takes the next step action, the route information after the next action taken according to the instantaneous input values is separated as output. By this means, the model becomes able to make route estimations by solving the correlation between input and output.

Supervised learning algorithms are also used to shorten the training time of reinforcement learning algorithms. The different scenarios using the rule-based behavior functions are run, and the actions chosen by the virtual entities at certain state values are collected as input and output data, and then the prepared model is trained. The virtual entity initializes from a reasonable policy based on the model generated by supervised learning and continues to learn according to its experiences with reinforcement learning.

Supervised learning algorithms can be used as a starting point for reinforcement learning, and they have another very critical function. This is the verification and analysis of the state and action space of the system. Since behavior is copied here, if the system is deficient, it is detected at this stage.

### Application of Reinforcement Learning Algorithms

Reinforcement learning is a learning technique that enables artificial intelligence based entities to find new tactics through trial and error and gain superiority over the opponent forces. Based on human learning, this method provides an opportunity to learn by exploration without any prior knowledge. An entity using a reinforcement learning technique tries to improve its behavior policy with the help of reward feedback signals received from the environment as a result of its decisions. This method can be used in conjunction with supervised learning. After achieving success in supervised learning with the datasets collected from the simulation, the model can be developed using reinforcement learning methods.

In the reinforcement learning part, the algorithm called “Proximal Policy Optimization” (PPO) was used as a baseline. This algorithm consists of components called the “actor” and the “critic”, which were also mentioned several times in previous end-of-term reports. These actor and critic networks are used among many algorithms that have proven their competence in the literature. The “actor”, also referred to as the “policy”, is a function approximator that takes the state-space and decides on actions. The “critic” is used only during learning, and not used when testing the learned model. The “critic” is a function approximator as well, and it is used to predict expected rewards (9) during training. This structure, which estimates the expected rewards (9), is used in some algorithms to accomplish the Bellman equations, and in some algorithms to reduce the reward (9) variance. Another advantage of having the Critic is that it allows the artificial intelligence to be updated from the experiences in the intermediate points without going to the end of the episode. The agents instantiated with the aforementioned algorithms correspond to virtual entities in the simulation. By this means, virtual entities based on reinforcement learning are trained with the gym training interface (4) in different scenarios. The training scenarios consist of air-to-air, air-to-ground, as the interaction of virtual entities deployed on land (Tanks, S-400 radar system) or in the air (SU-27, F-16 aircraft, etc.).

### Three-on-Three Air-to-Air Engagement Scenario RL Training

Virtual entities trained in this scenario aim to gain superiority against hostile virtual entities. In the scenario, the command and control virtual entity and 2 wing-man virtual entities, and 3 hostile virtual entities attempt to gain superiority over each other. According to the expected outcome, trained virtual entities should be superior over hostile virtual entities, engage with these aerial threats and pacify the hostile virtual entities with the right choices during the scenario. With the trainings, the hostile virtual entities are defeated by the intelligent virtual entities that are gradually learning and exploring new strategies.

### Single/Multiple Asset Trainings

In most of the widely used reinforcement learning environments, it is seen that the virtual entity restarts from the same fixed position or situation. Therefore, the generalization problem is ignored due to the low level complexity of such environments. In environments with higher complexity such as the simulator environment used in the invention, generalization becomes a more important problem. Generalization has various sub-domains such as location, role, and platforms in the environment. It is aimed to overcome this problem in terms of location by restarting the intelligent virtual entity from different locations.

On the other hand, due to the invention's ability to perform parallel multi-environment learning, intelligent virtual entities can be trained in isolated simulator instances. Assuming that the desired training scenario can be loaded into each simulator instance, the differences between scenarios can also be generalized since different scenarios can be run simultaneously in the same training. Standard reinforcement learning provided by the invention has some dynamics similar to those described in the literature. The unit of time that an intelligent virtual entity observes and performs actions in the simulator environment is called a step. When the number of steps reaches a certain limit or a termination criterion is met, the current state of the simulator environment is restarted and a new episode begins. The intelligent virtual entity tries to approach the optimal behavior model (5) by taking the most logical actions in accordance with the current state in the scenario during the episodes. However, the accepted behavior model (5) may not always be the best solution but a suboptimal one. An intelligent virtual entity tries to explore the environment by trying other possible actions, sometimes with the possibility of achieving more effective strategies. Thus, it becomes clear whether there is an alternative behavior model (5) that is more optimal than the current behavior model (5). The status of learning performance can be visualized online using the logging tools provided with the invention. Standard learning starts with a low score as a result of the initial irrational and random actions of an intelligent virtual entity, and ends with the learning of a behavior pattern (5) that achieves the maximum reward (9) by making progressively more rational decisions and increasing the score as result of observations and explorations of the simulator environment throughout all episodes.

Additionally, visualization tools are designed to observe the learning curve and analyze. During the training phase, the metrics are logged online and observed. When the reward function is designed categorically, each sub-reward component can also be logged separately. It also has the ability of interrupting the training and then continuing from the last saved checkpoint.

In addition, the system of the invention is capable of running multiple isolated simulation environments simultaneously, if the system used allows it. Thereby, comparisons can be made by running trainings of different concepts in parallel as far as is allowed by the simulation (3).

What is claimed is:

1. A self-improvement method of virtual entities with an artificial intelligence model in training simulators, comprising:
developing an optimal behavior model with deep learning approaches for intelligent virtual entities controlled with supervised learning algorithms,
connecting simulations with intelligent virtual assets to a training interface in training algorithms and thus intelligent virtual assets behaving as an interface, and
learning the appropriate behavior model by trial and error according to punishment-reward or objective function with reinforcement learning after a supervised learning training;
wherein the intelligent virtual entities generalize a simulation world map by restarting from different locations at the beginning of the episode, and
the intelligent virtual entities have an ability to perform parallel multi-training by generalizing between scenarios simultaneously.

2. The self-improvement method according to claim 1, wherein the training algorithms are deep learning algorithms.
